(19) United States
(12) Patent Application Publication
(10) Pub. No.: US 2018/0240049 A1
(43) Pub. Date: Aug. 23, 2018

(54) VERIFYING METHOD AND VERIFYING DEVICE

(71) Applicant: Acer Incorporated, New Taipei City (TW)

(72) Inventors: Chiu-Ling Wei, New Taipei City (TW); Zhe-Xuan Zhou, New Taipei City (TW); Liang-Chi Chen, New Taipei City (TW)

(73) Assignee: Acer Incorporated, New Taipei City (TW)

(21) Appl. No.: 15/594,488

(22) Filed: May 12, 2017

(30) Foreign Application Priority Data
Feb. 17, 2017 (TW) 106105391

(51) Int. Cl. G06Q 10/06; G07C 3/14; G06F 9/448; G06F 17/30

(52) U.S. Cl. CPC G06Q 10/06; G06F 17/30; G06F 9/448; G07C 3/14

(57) ABSTRACT

The invention provides a verifying method and a verifying device. The verifying method includes receiving a marketing requirement document (MRD) and a softload content list (SCL). The MRD includes a touch point information of a plurality of applications of a plurality of product lines. The SCL includes a name information and a version information of applications of one of the product lines. The verifying method further includes obtaining a first touch point information to be verified according to the MRD and the SCL. The first touch point information corresponds to a first application of the applications. The verifying method further includes searching a first application module corresponding to the first application from an application database according to the name information or the version information of the first application. The verifying method further includes verifying whether a touch point path of the first application module is valid.

### CROSS-REFERENCE TO RELATED APPLICATION

This application claims the priority benefit of Taiwan application serial no. 106105391, filed on Feb. 17, 2017. The entirety of the above-mentioned patent application is hereby incorporated by reference herein and made a part of this specification.

### FIELD OF THE INVENTION

The invention relates to a verifying method and a verifying device. More particularly, the invention relates to a verifying method and a verifying device that check whether an application module is complied with specifications of a marketing requirement document before an image file is deployed.

### DESCRIPTION OF RELATED ART

A marketing requirement document (MRD) is a structure configured to control an application binding rule and an application touch point under different product lines (e.g., home edition, professional edition, flagship edition, and etc.) and hardware specifications. An application module is required to store a path of the application touch point in a specific text file in advance and package the text file in the application module to meet regulations defined by the MRD.

Nevertheless, in a case that part of a definition on the application touch point is updated when a version of the MRD is changed (e.g., application contract expires) but a version of the application is not updated correspondingly, the deployment process is interrupted by an image file deployment tool when performing image file deployment because no touch point path file exists in the application module. A factory testing process is thereby forced to be interrupted. Problems have to be clarified first and then the image file being interrupted during the testing process has to be re-deployed at this time.

If the number of shipping regions defined in the MRD is, for example, 15, and the number of product lines of each of the shipping regions is, for example, 6, as such, 90 times of testing have to be performed on one MRD. In addition, several hours or so are consumed during every deployment process of the image file, more time and higher costs are thus needed during MRD testing as a result.

### SUMMARY OF THE INVENTION

The invention provides a verifying method and a verifying device configured to check whether an application module is complied with specifications of a marketing requirement document (MRD) in advance when the MRD is updated, so as to lower error rate during image file deployment and thus to enhance factory testing efficiency and reduce time and costs required for manufacturing the image file.

In an embodiment of the invention, a verifying method includes receiving a MRD and a softload content list (SCL). The MRD includes a touch point information of a plurality of applications of a plurality of product lines. The SCL includes a name information and a version information of applications of one of the product lines. The verifying method further includes obtaining a first touch point information to be verified according to the MRD and the SCL. The first touch point information corresponds to a first application of the applications. The verifying method further includes searching a first application module corresponding to the first application from an application database according to a name info nation or a version information of the first application. The verifying method further includes verifying whether a touch point path of the first application module is valid.

In an embodiment of the invention, the first touch point information includes a shortcut order of the first application located at a Start Screen or a Taskbar in one of the product lines.

In an embodiment of the invention, a step of verifying whether the touch point path of the first application module is valid includes determining whether the first application module exists in the application database. If the first application module exists in the application database, the first application module is decompressed and installed.

In an embodiment of the invention, the step of verifying whether the touch point path of the first application module is valid further includes determining whether the touch point path exists in a folder of the first application module.

In an embodiment of the invention, the step of verifying whether the touch point path of the first application module is valid further includes comparing the touch point path with the MRD to verify whether the touch point path is valid if the touch point path exists in the folder of the first application module.

In an embodiment of the invention, a verifying device includes a processor and a memory coupled to the processor. The processor receives a MRD and a SCL. The MRD includes a touch point information of a plurality of applications of a plurality of product lines. The SCL includes a name information and a version information of applications of one of the product lines. The processor obtains a first touch point information to be verified according to the MRD and the SCL. The first touch point information corresponds to a first application of the applications. The processor searches a first application module corresponding to the first application from an application database according to a name information or a version information of the first application. The processor verifies whether a touch point path of the first application module is valid.

In an embodiment of the invention, the first touch point information includes a shortcut order of the first application located at a Start Screen or a Taskbar in one of the product lines.

In an embodiment of the invention, the processor determines whether the first application module exists in the application data base. The processor decompresses and installs the first application module if the first application module exists in the application database.

In an embodiment of the invention, the processor determines whether the touch point path exists in a folder of the first application module.

In an embodiment of the invention, the processor compares the touch point path with the MRD to verify whether the touch point path is valid if the touch point path exists in the folder of the first application module.

In view of the foregoing, in the verifying method and the verifying device provided by the embodiments of the invention, when verifying whether the touch point path of the first application module is valid, whether the first application module exists in the application database is first determined. If the first application module exists in the application database, the first application module is decompressed and installed. Next, whether the touch point path exists in the folder of the first application module is determined. Finally, the touch point path and the MRD are compared to verify whether the touch point path is valid. As such, whether the application module is complied with specifications of the MRD may be checked in advance to lower error rate when the image file is deployed.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a verifying device according to an embodiment of the invention.

FIG. 2 is a flowchart of a verifying method according to an embodiment of the invention.

### DESCRIPTION OF THE EMBODIMENTS

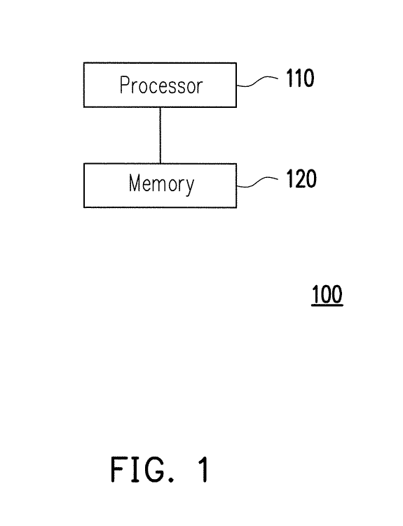

FIG. 1 is a block diagram of a verifying device according to an embodiment of the invention.

Referring to FIG. 1, a verifying device 100 provided by the embodiments of the invention includes a processor 110 and a memory 120 coupled to the processor 110. The processor 110 may be a central processing unit (CPU), a microprocessor, a digital signal processor (DSP), a programmable controller, a microcontroller unit, an application specific integrated circuit (ASIC), a programmable logic device (PLD), or other similar devices. The memory 120 may include a volatile memory (e.g., a dynamic random access memory) and a non-volatile memory (e.g. storage devices such as a hard disk drive, a solid state drive, or a flash memory) for storing data of the verifying device 100 temporarily or for a long time.

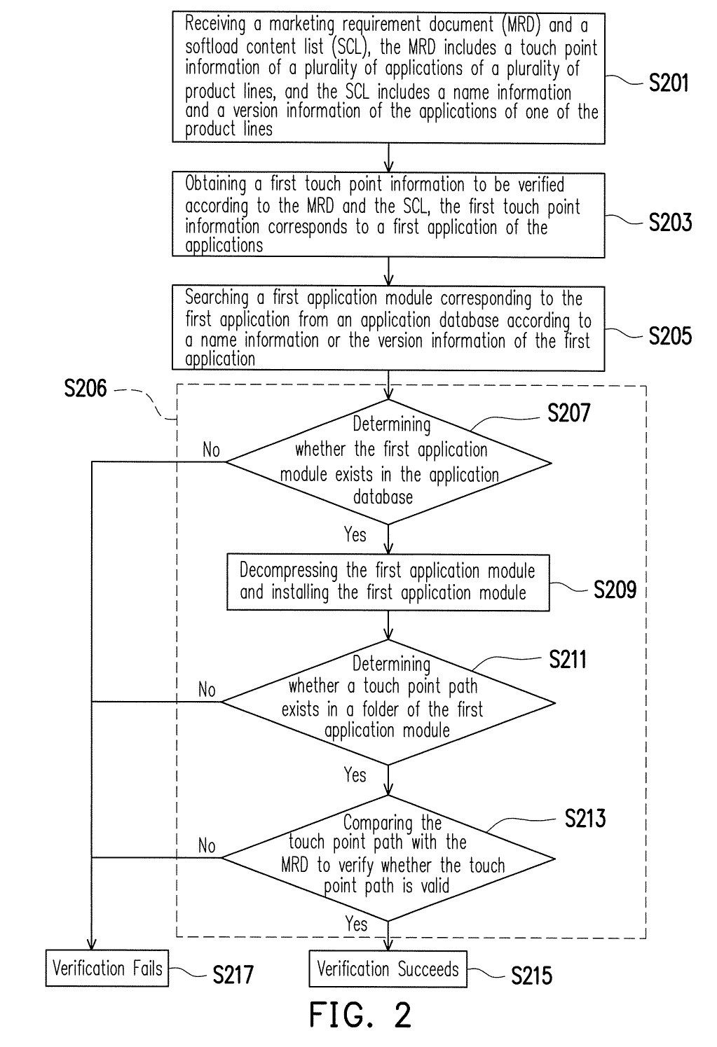

FIG. 2 is a flowchart of a verifying method according to an embodiment of the invention.

Referring to FIG. 2, in step S201, the verifying device 100 may receive a marketing requirement document (MRD) and a softload content list (SCL). The MRD includes a touch point information of a plurality of applications of a plurality of product lines (a.k.a. a form factor). The SCL includes a name information and a version information of the applications of one of the product lines.

Specifically, when a version of the MRD is updated, a new version of the MRD is issued by a product manager of the software. The SCL may be applied at a product lifecycle management (PLM) server by a personnel responsible for image file verification to perform image file verification. In addition to the name information and the version information of the applications of one of the product lines, the SCL may further include a silent install information of the applications of one of the product lines. The silent install refers to an application installing process without the requirement of user interaction. As such, the silent install may also be called as automatic install.

It is worth noting that the touch point information of the applications is a shortcut order of the applications located at a Start Screen or a Taskbar in a specific product line of a specific shipping region (or a language region). For instance, an order of a corresponding image of the shortcut of the applications at the Start Screen or the Taskbar is recorded by the touch point information.

In step S203, the processor 110 may obtain a first touch point information to be verified according to the MRD and the SCL. The first touch point information corresponds to a first application of the applications. In other words, an application to be verified and a touch point information of the application may be obtained by the processor 110 according to the name information and the version information of the applications of the SCL.

In step S205, the processor 110 may search a first application module corresponding to the first application from an application database according to a name information or a version information of the first application. In another embodiment, the processor may also search the first application module corresponding to the first application from the application database according to a silent install information of the first application.

In step S206, the processor 110 may verify whether a touch point path of the first application module is valid. Specifically, step S206 may also include step S207, step S209, step S211, and step S213.

In step S207, the processor 110 may determine whether the first application module exists in the application database.

If the first application module exists in the application database, in step S209, the processor 110 decompresses the first application module. If the first application module does not exist in the application database, in step S217, verification fails.

In step S211, the processor 110 may further determine whether the touch point path exists in a folder of the first application module. If the touch point path does not exist in the folder of first application module, in step S217, verification fails.

If the touch point path exists in the folder of the first application module, in step S213, the processor 110 may compare the touch point path and the MRD to verify whether the touch point path is valid. If the touch point path is valid, in other words, if the touch point path in the folder of the first application module is identical to the touch point path of the first application of the product line recorded in the MRD, in step S215, verification succeeds. If the touch point path is invalid, meaning that if the touch point path in the folder of the first application module is different from the touch point path of the first application of the product line recorded in the MRD, in step S217, verification fails.

Table 1 is an example of the touch point info′ cation according to an embodiment of the invention.

TABLE 1
Touch Point Information

| | Touch Point Name in | Touch Point File Name in |
|---|---|---|
| Touch Point Type | MRD | Application Module |
| Start Screen | Metro Apps | AUMID*.txt |
| Taskbar | Desktop Taskbar Pin | TaskbarLink.txt |
| MFU | MFU | MFUlink.txt |
| Notification Area | System Notification | NotificationArea.txt |
| | Area Icon | |

Specifically, the touch point information of applications of a product line is recorded in the MRD. The touch point information includes a touch point type (e.g., the Start Screen, the Taskbar, or etc.) and records where the application creates the shortcut. The touch point information further includes a touch point name in the MRD. The touch point information further includes a touch point file name in the application module. After the application module is decompressed and installed, the processor 110 may check whether a touch point file (e.g., AUMID*.txt) of the first application corresponding to the product line exists in a folder created after installing the first application module. If the touch point file of the first application corresponding to the product line in the MRD exists in the folder, the processor 110 may further determine whether a touch point path recorded in the touch point file is identical to the touch point path recorded in the MRD to determine whether verification of the touch point succeeds.

To sum up, in the verifying method and the verifying device provided by the embodiments of the invention, when verifying whether the touch point path of the first application module is valid, whether the first application module exists in the application database is first determined. If the first application module exists in the application database, the first application module is decompressed and installed. Next, whether the touch point path exists in the folder of the first application module is determined. Finally, the touch point path and the MRD are compared to verify whether the touch point path is valid. As such, whether the application module is complied with the specifications of the MRD may be checked in advance to lower an error rate when the image file is deployed and thereby, to further enhance factory testing efficiency and to reduce the time and costs required for remanufacturing the image file.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A verifying method, comprising:
receiving a marketing requirement document (MRD) and a softload content list (SCL), wherein the MRD comprises a touch point information of a plurality of applications of a plurality of product lines, the SCL comprises a name information and a version information of the applications of one of the product lines;
obtaining a first touch point information to be verified according to the MRD and the SCL, wherein the first touch point information corresponds to a first application of the applications;
searching a first application module corresponding to the first application from an application database according to the name information or the version information of the first application; and
verifying whether a touch point path of the first application module is valid.

2. The verifying method as claimed in claim 1, wherein the first touch point information comprises a shortcut order of the first application located at a Start Screen or a Taskbar in one of the product lines.

3. The verifying method as claimed in claim 1, wherein a step of verifying whether the touch point path of the first application module is valid comprises:
determining whether the first application module exists in the application database; and
decompressing the first application module and installing the first application module if the first application module exists in the application database.

4. The verifying method as claimed in claim 3, wherein the step of verifying whether the touch point path of the first application module is valid further comprises:
determining whether the touch point path exists in a folder of the first application module.

5. The verifying method as claimed in claim 4, wherein the step of verifying whether the touch point path of the first application module is valid further comprises:
comparing the touch point path with the MRD to verify whether the touch point path is valid if the touch point path exists in the folder of the first application module.

6. A verifying device, comprising:
a processor; and
a memory, coupled to the processor,
wherein the processor receives a MRD and a SCL, wherein the MRD comprises a touch point information of a plurality of applications of a plurality of product lines, the SCL comprises a name information and a version information of the applications of one of the product lines,
wherein the processor obtains a first touch point information to be verified according to the MRD and the SCL, wherein the first touch point information corresponds to a first application of the applications,
wherein the processor searches a first application module corresponding to the first application from an application database according to the name information or the version information of the first application,
wherein the processor verifies whether a touch point path of the first application module is valid.

7. The verifying device as claimed in claim 6, wherein the first touch point information comprises a shortcut order of the first application located at a Start Screen or a Taskbar in one of the product lines.

8. The verifying device as claimed in claim 6, wherein the processor determines whether the first application module exists in the application database, wherein the processor decompresses the first application module and installs the first application module if the first application module exists in the application database.

9. The verifying device as claimed in claim 8, wherein the processor determines whether the touch point path exists in a folder of the first application module.

10. The verifying device as claimed in claim 9, wherein the processor compares the touch point path with the MRD to verify whether the touch point path is valid if the touch point path exists in the folder of the first application module.
